(19) United States
(12) Patent Application Publication
(10) Pub. No.: US 2010/0121954 A1
(43) Pub. Date: May 13, 2010

(54) Communication Method and System Using User ID-Based Domain Name

(76) Inventors: Zheng Yang, Sunnyvale, CA (US); Zhe Wang, Princeton, NJ (US)

Correspondence Address: NORTH WEBER & BAUGH LLP, 2479 E. BAYSHORE ROAD, SUITE 707, PALO ALTO, CA, 94303, US

(21) Appl. No.: 12/270,594

(22) Filed: Nov. 13, 2008

(51) Int. Cl. G06F 15/16; H04L 9/32

(52) U.S. Cl. 709/225; 726/4

(57) ABSTRACT

A method of communication is provided, which comprises assigning a first domain name by a server to a first user when the first user logs onto the server using a first device, the first domain name being associated with a first device identifier of the first device and a first user identifier of the first user; and negotiating communication for the first device based on the first domain name despite of the IP address of the first device. Other embodiments are disclosed. By way of the present invention, a secure and convenient resource sharing and access control may be achieved.

### BACKGROUND

A. Technical Field

The present invention relates to communication field, and more specifically, to a method and system negotiating communication using a domain name associated with a user name.

B. Background of the Invention

For the common usage of Internet or wireless communication, devices such as PCs and communication devices can not only connect all over the world, but also share documents, photos, audio and video files, applications running thereon, and the like, thereby improving the efficiency of resource utilization.

Currently, there are several solutions related to securely and easily sharing resources, (i.e. to publish content privately) such as sharing photos with family or friends, sharing documents and spreadsheets with colleagues, and publishing content that only an allowed user can view. For example, a Blog is commonly used to publish photos and documents. However, a Blog is typically semi-public, and has a storage quota as well as certain privacy issues. Another solution is to run a web server on a home machine, which oftentimes has connectivity issue due the difficulty of getting a publicly accessible IP, and also most of the home machines are behind a NAT or WiFi access point so it is hard to be reached without adjusting network configurations. Current P2P file sharing systems have little access control, and can hardly meet the security requirements. Another common usage is to remote access the screen of another computer. However, with wide deployment of firewalls and NATs, it is difficult to do such remote access without expert knowledge of network configurations.

Thus, there is a need for a new system and method for convenient and secure resource sharing and access control.

### SUMMARY OF THE INVENTION

According to one aspect of the present invention, a method of communication is provided, the method comprises assigning a first domain name by a server to a first user when the first user logs onto the server using a first device, the first domain name being associated with a first device identifier of the first device and a first user identifier of the first user; and negotiating communication for the first device based on the first domain name despite of the IP address of the first device. The method further comprises assigning a second domain name to a second user when the second user logs onto the server using a second device, the second domain name being associated with a second device identifier of the second device and a second user identifier of the second user. The method further comprises controlling access from the first device to the second device by the first user identifier, and allowing or disallowing the first user to see the second device. The method further comprises assigning a third domain name to the first user when the first user logs onto the server using a third device, the third domain name being associated with a third device identifier of the third device and the first user identifier; and allowing the third device to access the second device if the first device is allowed to access the second device (i.e., the access control can be set to be user based rather than device based).

In an embodiment, the method further comprises authenticating any device assigned with a domain name being associated with the first device identifier to access any application running on the second device if the first user is allowed by the second user to access the second device, the authenticating comprising specifying whether the first user can access a particular application running on the second device by the second user. In an embodiment, the specifying comprises blocking or unblocking the first user's access to a particular port on which the particular application runs to disallow or allow access to the particular application.

In another embodiment, the method further comprises sharing at least one resource between the first device and the second device if the first user is allowed by the second user to access the second device. According to various embodiments, the IP address of the first device is a public IP address or a private IP address. In an embodiment, the first domain name is further associated with an identifier of the server. In an embodiment, the first domain name comprises a portion in a form of “device identifier. user identifier. server identifier”.

The exact form of a server identifier can vary. For example, it could be different server identifiers for different organizations or it could be in a form of general hierarchical name which can be further split into “group_identifier.organization_identifier” etc. As a result, it can be easily understood that different security policies and configurations can be defined and deployed at any intermediate level (such as group level or organization level).

According to another aspect of the present invention, there could be a computer-readable medium comprising instructions stored thereon, when executed by a computer, the instructions causing the computer to assign a first domain name to a first user when the first user logs on using a first device, the first domain name being associated with a first device identifier of the first device and a first user identifier of the first user; and negotiate communication for the first device based on the first domain name despite of the IP address of the first device. The instructions further cause the computer to assign a second domain name to a second user when the second user logs on using a second device, the second domain name being associated with a second device identifier of the second device and a second user identifier of the second user. The instructions further cause the computer to control access from the first device to the second device by the first user identifier. The instructions further cause the computer to allow or disallow the first user to see the second device. In an embodiment, the instructions further causes the computer to assign a third domain name to the first user when the first user logs onto a third device, the third domain name being associated with a third device identifier of the third device and the first user identifier and allow the third device to access the second device if the first device is allowed to access the second device.

In an embodiment, the instructions further cause the computer to authenticate any device assigned with a domain name being associated with the first device identifier to access any application running on the second device if the first user is allowed by the second user to access the second device. In one embodiment, the authenticating comprises specifying whether the first user can access a particular application running on the second device by the second user, and the specifying comprises blocking or unblocking the first user's access to a particular port on which the particular application runs to disallow or allow access to the particular application.

In an embodiment, the instructions further cause the computer to share at least one resource between the first device and the second device if the first user is allowed by the second user to access the second device. In various embodiments, the IP address of the first device is a public IP address or a private IP address, and the first domain name is further associated with an identifier of the server. In one embodiment, the first domain name comprises a portion in a form of “device identifier. user identifier. server identifier”.

According to yet another aspect of the present invention, it provides a system of communication, comprising a server; and a first device used by a first user; wherein the server assigns a first domain name to the first user when the first user logs onto the server using the first device, the first domain name being associated with a first device identifier of the first device and a first user identifier of the first user; and negotiates communication for the first device based on the first domain name despite of the IP address of the first device. In an embodiment, the system further comprises a second device used by a second user, and the server further assigns a second domain name to the second user when the second user logs on the server using the second device, the second domain name being associated with a second device identifier of the second device and a second user identifier of the second user. In one embodiment, the server controls access from the first device to the second device by the first user identifier. In one embodiment, the server allows or disallows the first user to see the second device. In an embodiment, the server further: assign a third domain name to the first user when the first user logs on the server using a third device, the third domain name being associated with a third device identifier of the third device and the first user identifier; and allow the third device to access the second device if the first device is allowed to access the second device.

In an embodiment, any device assigned with a domain name being associated with the first device identifier is authenticated to access any application running on the second device if the first user is allowed by the second user to access the second device. In an embodiment, the authenticating comprises specifying whether the first user can access a particular application running on the second device by the second user, and the specifying comprises blocking or unblocking the first user's access to a particular port on which the particular application runs to disallow or allow access to the particular application.

In one embodiment, at least one resource is shared between the first device and the second device if the first user is allowed by the second user to access the second device. In various embodiments, the IP address of the first device is a public IP address or a private IP address and wherein the first domain name is further associated with an identifier of the server. In a specific embodiment, the first domain name comprises a portion in a form of “device identifier. user identifier. server identifier”.

### BRIEF DESCRIPTION OF THE DRAWINGS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invent. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

FIG. 1 illustrates a traditional communication system.

FIG. 2 illustrates a communication system according to one embodiment of the present invention, showing how communication and access control are implemented between two devices used by two different users.

FIG. 3 illustrates a communication system according to another embodiment of the present invention, showing how access control are implemented between a plurality of devices used by different users.

FIG. 4 illustrates a communication system according to yet another embodiment of the present invention, showing how communication is implemented between a plurality of devices used by a same user.

### DETAILED DESCRIPTION OF THE PREFERRED EMBODIMENTS

The following description is set forth for purpose of explanation in order to provide an understanding of the invention. However, it is apparent that one skilled in the art will recognize that embodiments of the present invention, some of which are described below, may be incorporated into a number of different computing systems and devices. The embodiments of the present invention may be present in hardware, software and/or firmware. Structures and devices shown below in block diagram are illustrative of exemplary embodiments of the invention and are meant to avoid obscuring the invention. Furthermore, connections between components within the figures are not intended to be limited to direct connections. Rather, data between these components may be modified, re-formatted or otherwise changed by intermediary components.

Reference in the specification to “one embodiment”, “in one embodiment” or “an embodiment” etc. means that a particular feature, structure, characteristic, or function described in connection with the embodiment is included in at least one embodiment of the invention. The appearances of the phrase “in one embodiment” in various places in the specification are not necessarily all referring to the same embodiment.

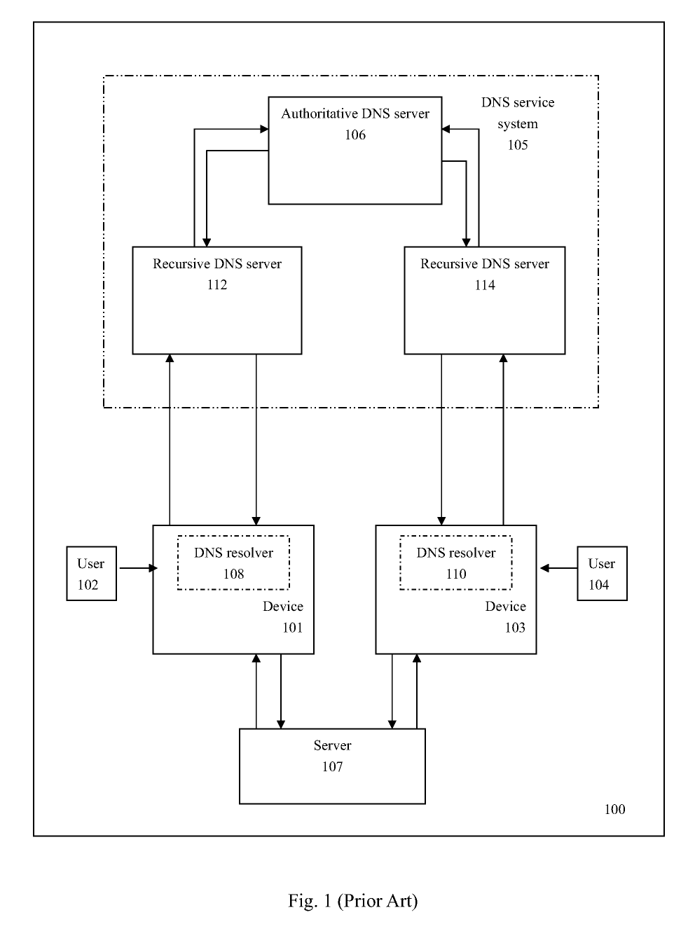

FIG. 1 illustrates a traditional communication system 100. Communication system 100 includes two devices 101 and 103 used by two separate users, a server 107 and a DNS service system 105. As those skilled in the art will understand, the devices 101 and 103 may have necessary features or functionality. For example, the devices 101 may include an operation system, at least one application which may run on the operation system and a data storage device (removable and/or non-removable) for storing information, media contents and the like. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the device. Similarly, the device 103 may include necessary features or functionality.

In order for the device 101 (for example, a computer) used by a user 102 to communicate with a device 103 (for example, a laptop) used by a user 104, users 102 and 104 may log onto the server 107 with their pre-registered user identifier (or user name), which are Alice for user 102 and Bob for user 104. Subsequently, an alphabetic domain name of alice.servername.net and an alphabetic domain name of bob.servername.net are respectively assigned to the devices 101 and 103 by the server 107. When the devices 101 and 103 require communication, the devices 101 and 103 rely on the DNS service system 105 to translate the alphabetic domain names into actual IP addresses. As illustrated, the DNS system 105 may include a root DNS server—authoritative DNS server 106, and recursive DNS servers 112 and 114 as well as the DNS resolvers 108 and 110 that are respectively located in the devices 101 and 103. Through the DNS system, the computer 101 is able to look up the IP address of computer 103, and vice versa. Thus, the devices 101 and 103 may communicate with each other based on their IP addresses. The devices 101 and 103 may share files, applications and desktops there between after a communication link is created.

For the security concern, the devices 101 and 103 may need to implement access controls. For example, the device 101 may implement a firewall which functions based on a predetermined rule set. Since the firewall cannot access application layer information about which user is accessing the service, so it is common for current technology to use IP addresses based authentication to control access. For example, owner of device 101 can configure that only the device with IP address that corresponds to device 103 is allowed to communicate with 101. But in current mobile world (or due to DHCP or NAT issue), the device 103's IP address can change every time it accesses Internet.

Alternatively, some kind of user access control may be implemented at the application layer, this would involve “per-application” configuration. This lacks flexibility and requires per application configuration for user creation and access control.

When the user 102 needs to use another communication device, such as a mobile phone, to log onto the server 107, the server 107 will consider that the device 101 used by the same user is logged off, disconnect current link of the device 101, and assign the domain name Alice.servername.net to the mobile phone. Thus, the prior art system has the disadvantage that a same user may only use one device at a time. It is inconvenient sometime. For example, if the user 102 desires to share two different files located at two separate devices with the user 104, he has to firstly log on with the first device, create a communication using the first device, implement file transfer, and then log on with the second device, create the communication using the second device, and begin a same procedure all over again. It is time consuming, and communication such as resource sharing between two different devices belongs to a same user cannot be achieved with this system.

For system incorporating NAT, which is common nowadays, for example, programmers have to devise specific tunneling methods to penetrate different types of NATs for IP applications in the above system. Such difficulties are expected to become significantly worsened after an increasing number of users are connected and using of peer-to-peer IP applications such as online games, IP phones, file sharing programs, online collaboration applications, IPTV, instant messenger and other types of interactive applications.

The objective of the present application is to overcome the above obstacles encountered by the prior art and provide a system and method for convenient and secure resource sharing and access controlling, and it is achieved by the following solutions.

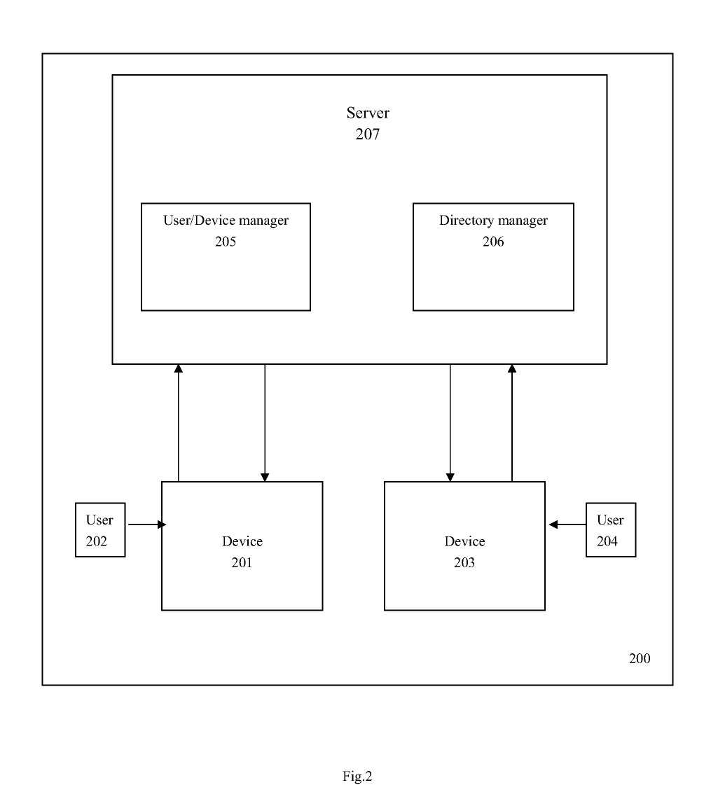

Now referring to FIG. 2, a communication system 200 according to the present invention is illustrated. The communication system 200 includes two devices 201 and 203 used by two separate users, a server 207. As mentioned above, the devices 201 and 203 may have necessary features or functionality.

When a user 202, with a pre-registered user identifier Alice, uses the device 201 (for example, a laptop) to log on the server 207, an alphabetic domain name of laptop.alice.servername.net is assigned to the devices 201 by the server 207. Similarly, when a user 204, with a pre-registered user identifier Bob, uses the device 203 (for example, a PC in Bob's office) to log on the server 207, an alphabetic domain name of officePC.bob.servername.net is assigned to the devices 203 by the server 207, wherein the portion of “officePC” can be any name Alice picked for device 201. In various embodiments, the exact form of server identifier can vary. For example, it could be different server identifiers for different organizations. Alternatively, the server identifier could be in a form of general hierarchical name which can be further split into “group_identifier.organization_identifier” etc. As a result, it can be easily understood that different security policies and configurations can be defined and deployed at any intermediate level (such as group level or organization level).

In the system 200, the server 207 may negotiate communications for devices 201 and 203 based on the domain names being associated with the device identifiers (such as the “laptop” and “officePC” portion in the above domain names) and the user identifiers despite of the actual IP addresses of the devices 201 and 203.

In one embodiment, the server 207 would help these two devices to communicate with each other by either helping them to directly connect to each other via their external IP address, or helping them to create a relay channel via a third device (or it could be server 207 itself) that has an external IP that is visible to both devices. In another embodiment, the devices 201 and 203 may only have internal IP addresses rather than public IP addresses, and thus the communication between two devices is encapsulated in a communication tunnel. For more details, one may refer to U.S. application Ser. No. 11/359,340, filed on Feb. 22, 2006 by the present applicants, which is incorporated herein in its entity by reference.

An example communication process is described in great details above. However, those skilled in the art will understand that the details are presented to illustrate the invention, and the present invention may be implemented without these specific details.

The communication system 200 may easily implement resource sharing and per-user access control.

The server 207 may includes a user/device manager 205, which maintains a list of users which has logged on and an associated device list of devices used by the users. The user/device manager 205 discovers all logged on devices and users. By the assistance of the user/device manager 205, a logged on device may have a chance to know who is online and with whom a communication may be facilitated.

In the system 200, the server 207 may also include a directory manager 206, which functions to collect and renew information about each registered user. For example, when the device 201 logs on with the name Alice, the device 201 may send a request to the directory manager 206, which contains the a designated device name, a pre-registered user name, a list of resources available for sharing, and visibility controlling rules. For example, when the device 201 logs on, it may send a request containing information that: a laptop of Alice is logging on; files a, b, and c are available for sharing; Only Jim is allowed to see the device 201. The directory manager 206 stores the received device name, the user name, the list of resources for sharing and the access controlling rules for example in a database, and returns a message indicating successful operation. The directory manager 206 may also receive request from devices for changing resources for sharing and/or the visibility controlling rules. In an alternative implementation, the directory information and access control can be stored or implemented locally on individual devices. Since resource control is per target resource, thus it is possible for individual local device to store the access control information and implement control locally. Such implementation reduces the burden of a central directory manager, thus allow easier implementation of server 207 and allow using existing implemented relay servers.

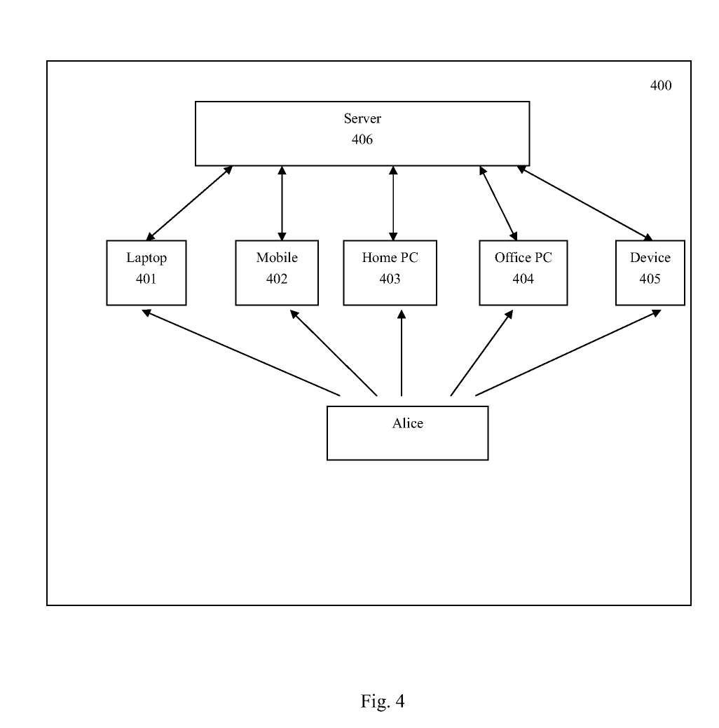

With the functionalities of the user/device manager 205 and the directory manager 206, resource sharing is conveniently achieved. This will be further described below by referring to FIG. 4.

The present communication system may also implement a user-based access control for the devices 201 and 203. In an implementation, the access control is implemented based on the other party's identity, and also such an access control may be applied to different applications at application level. Since the platform implicitly requires the user to log on to the server when it starts, the present invention has the capability to authenticate each user and then bring that fact to other users. As a result, any user can define rules for access control based on the other party's true identity rather than IP address. The other party does not need to do extra authentication since the platform itself already handles all the authentication issue. The end application does not need to be recoded or recompiled to take advantage of such framework since our access control is hidden in the normal standard IP network.

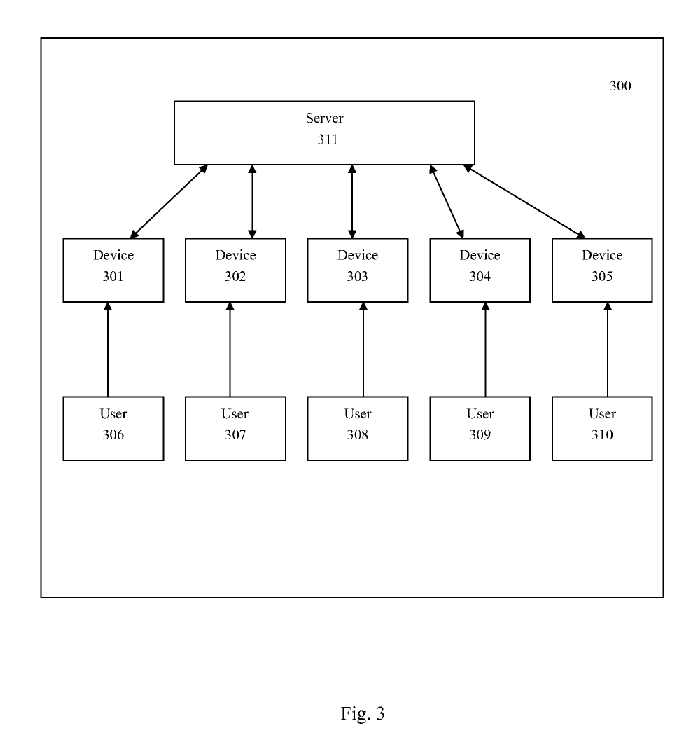

In order to further illustrate the functions and advantages of the present invention, references will be made to FIGS. 3 and 4 below. FIG. 3 illustrates a communication system 300 according to the present invention. The communication system 300 includes five devices 301 to 305, each being used by a different user 306 to 310 (Alice, Bob, Jim, Alice's mom, Bob's brother). The system 300 includes a server 311, which has similar components and functions as server 207 described above referring to FIG. 2, and will not be repeated herein.

When the user 306, with the user identifier Alice, uses the device 301 (which is a laptop) to log on the server 311, the device 301 sends a request to the server 311, which may indicate that: a laptop of Alice is logging on; folders A, B and applications C, D are available for sharing; Alice's mom and Bob are allowed to see the device 301. The server 311 receives the request from the device 301, stores all the above information, assigns a domain name of laptop.Alice.servemame.net to the device 301. Since the device 301 requests to be seen by Alice's mom and Bob, the server 311 further notifies availability of the device 301 used by Alice to the devices 302 and 304 used by Alice's mom and Bob respectively. When bob logins, it will contact with Alice's laptop to know what resources are available to bob, the information does not need to be stored in server 311.

Alternatively, in another example, whether a folder is shared with whom, as well as who is permitted to access which application, may be stored on Alice's laptop, rather than on server 311. By employing such a solution, the server may be taken off the burden of storing such control information for each device and may keep as little centralized information as possible. The present invention is not limited in this aspect.

In an embodiment, Alice may request the server 311 to maintain a friend list for her, which contains identifiers (or names) of users with whom she wants to share her availability when she logs on. Thus, when Alice logs on using any device, the users in her corresponding friend list may be notified by the server 311 of Alice's availability without additional request sent by the device used by Alice.

Alice may also implement an access control rule set based on user identifiers. For example, Alice may set that the user 309 is authenticated to access any folders or applications for sharing, and Bob (the user 307) is only allowed to access the folder A and the application C.

The device 301 may also implement a group access control. For example, the device 301 may set a family group, a close friend group and a stranger group, wherein all documents and applications running on the device 301 may be accessed by the users in the family group, documents with designated file type and all applications may be accessed by the users in the close friend group, while access of those in the stranger group should be designated one by one. Therefore, an access control by groups may be easily achieved. For example, the device 301 may assign Bob to the close friend group, assign Jim and Bob's brother to the stranger group, while Alice's mom to the family group. Furthermore, it is also possible to have an administrator who configures a “group” policy (or domain policy, when a user is part of a particular domain), so anyone who would like to join the group (or domain) can automatically use the “group” policy for security enforcement between group members. It would be very useful in the case of enforcing access control within a business unit and such.

The access control may also be implemented on resource basis. That is to say that for each document or application, the device 301 may designate that which users are allowed to access. For example, Alice may specify that all photos may be accessed by Bob and Jim, application A may be accessed by Bob, Bob's brother, while application B may be accessed by Alice's mom. In an embodiment, whenever a new application begins to run, the device may request the user to specify which user or users may have access to the application. In one embodiment, disallowing or allowing access to the application is achieved by blocking or unblocking access to a particular port on which the application runs. However, those skilled in the art may understand that the present invention is not so limited.

When a device (for example device 305) is trying to access folder A on device 301, the device 301 firstly acquires the domain name of the device 305, figures out the user identifier portion of the domain name (in this case Bob's brother). Then the device 301 may check which group Bob's brother belongs to. Since Bob's brother is in the stranger group, the device 301 may notify to specify which resources may be accessed by the device 305. Alternatively, if the access control is implemented on resource basis, the device 301 may check which resource is allowed to be access by Bob's brother. If there is at least one resource is allowed to be accessed by Bob's brother, the device 305 is allowed to access that resource on device 301.

Since the access control is implemented based on user name (i.e. user identifier), if Bob is allowed to access resource A, then another device, for example device 305, which is used by Bob previously and is not blocked from accessing resource A, may be allowed to access resource A as long as now the device 305 is logged on with the user name Bob.

FIG. 4 shows another communication system 400 according to the present invention, which illustrates how the present invention facilitates resource sharing between different devices belonging to a same user Alice. The system 400 includes a laptop 401, a mobile phone 402, a PC at home 403, a PC 404 located in office, an device 405 and a server 406. According to the present invention, domain names “laptop.Alice.servername.net”, “mobile.Alice.servemame.net”, “homePC.Alice.servemame.net”, “officePC.Alice.servername.net” and “device.Alice.servername.net” are assigned to the devices. Thus, the system according the present invention allows a same user using different devices to log on simultaneously. In one embodiment, since these devices belong to the same user and have domain names being associated with a same user identifier, they are automatically allowed to access each other. Note that, for some sensitive application or folders, it is still possible for Alice to setup a protection for an application or a folder on some of her machines (eg: private_work folder on officePC) so that other machines of hers cannot direct access these resources.

Except for the advantage of more than one device being allowed to log on with a same user name, the present embodiment actually largely facilitates personal resource sharing. A user may easily acquire resources located in his different devices. Specially, the present embodiment largely facilitates files backup and synchronization. For example, the mobile phone application will then be able to see a homePC which belongs to the same user as lone as homePC is also logged on to the system. It may access homePC's resource easily as a result. It can also access other user's resource if those users allow user 102 to do so.

In the description above, user name and user identifier are used interchangeably to refer to an identification which may be used to distinguish different users registered to the server.

In the description above, the domain name assigned by the server is described in the form of “device identifier. user identifier. server identifier”. However, those skilled in the art may appreciate that this form is only used for illustration, and other forms may be employed, as long as the domain name is associated with the user and the device used thereby.

In the description above, the term resource sharing includes, but not limited to, making documents, files, applications available for reading, transferring, copying or other common processing to the resource. For example, if the resource is an audio or video file, the term resource sharing includes playing, copying and transferring of the audio or video file.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than on of the additional element.

Although flow diagrams may have been used herein to describe embodiments, the inventions are not limited to those diagrams or to corresponding descriptions herein. For example, flow need not move through each illustrated box or exactly in the same order as illustrated and described herein.

Some embodiments of the invention may be implemented, for example, using a machine-readable medium or article which may store an instruction or a set of instructions that, if executed by a machine, cause the machine to perform a method and/or operations in accordance with embodiments of the invention. Such machines may include, for example, any suitable processing platform, computing platform, computing device, processing device, computing system, processing system, computer, processor, or the like, and may be implemented using any suitable combination of hardware and/or software. The machine-readable medium or articles may include, for example, any suitable type of memory unit, memory device, memory article, memory medium, storage device, storage article, storage medium and/or storage unit, for example, memory, removable or non-removable media, erasable or non-erasable media, writable or re-writable media, digital or analog media, hard disk, floppy disk, Compact Disk Read Only Memory (CD-ROM), Compact Disk Recordable (CD-R), Compact Disk Rewritable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present with unnecessary detail.

We claim:

1. A method of communication, comprising:
assigning a first domain name to a first user in relation to the first user logging onto a server using a first device, the first domain name being associated with a first device identifier of the first device and a first user identifier of the first user; and
negotiating communication for the first device based on the first domain name and independent of an IP address of the first device.

2. The method of claim 1, further comprising:
assigning a second domain name to a second user when the second user logs onto the server using a second device, the second domain name being associated with a second device identifier of the second device and a second user identifier of the second user.

3. The method of claim 2, further comprising:
controlling access from the first device to the second device by the first user identifier.

4. The method of claim 3, further comprising:
allowing or disallowing the first user to see the second device.

5. The method of claim 3, further comprising:
assigning a third domain name to the first user when the first user logs onto the server using a third device, the third domain name being associated with a third device identifier of the third device and the first user identifier; and
allowing the third device to access the second device if the first device is allowed to access the second device.

6. The method of claim 3, further comprising:
authenticating any device assigned with a domain name being associated with the first device identifier to access any application running on the second device if the first user is allowed by the second user to access the second device.

7. The method of claim 6, the authenticating comprising:
specifying whether the first user can access a particular application running on the second device by the second user.

8. The method of claim 7, the specifying comprising:
blocking or unblocking the first user's access to a particular port on which the particular application runs to disallow or allow access to the particular application.

9. The method of claim 6, further comprising:
sharing at least one resource between the first device and the second device if the first user is allowed by the second user to access the second device.

10. The method of claim 1, wherein the IP address of the first device is a public IP address or a private IP address.

11. The method of claim 1, wherein the first domain name is further associated with an identifier of the server.

12. The method of claim 1, wherein the first domain name comprises a portion in a form of “device identifier. user identifier. server identifier”.

13. A computer-readable medium comprising instructions stored thereon, when executed by a computer, the instructions causing the computer to:
assigning a first domain name to a first user in relation to the first user logging onto a server using a first device, the first domain name being associated with a first device identifier of the first device and a first user identifier of the first user; and
negotiating communication for the first device based on the first domain name and independent of an IP address of the first device.

14. The computer-readable medium according to claim 13, when executed, the instructions further causing the computer to:
assign a second domain name to a second user when the second user logs on using a second device, the second domain name being associated with a second device identifier of the second device and a second user identifier of the second user.

15. The computer-readable medium according to claim 14, when executed, the instructions further causing the computer to:
control access from the first device to the second device by the first user identifier.

16. The computer-readable medium according to claim 15, when executed, the instructions further causing the computer to:
allowing or disallowing the first user to see the second device.

17. The computer-readable medium according to claim 15, when executed, the instructions further causing the computer to:
assign a third domain name to the first user when the first user logs on using a third device, the third domain name being associated with a third device identifier of the third device and the first user identifier; and
allow the third device to access the second device if the first device is allowed to access the second device.

18. The computer-readable medium according to claim 15, when executed, the instructions further causing the computer to:
authenticate any device assigned with a domain name being associated with the first device identifier to access any application running on the second device if the first user is allowed by the second user to access the second device.

19. The computer-readable medium according to claim 18, the authenticating comprising:
specifying whether the first user can access a particular application running on the second device by the second user.

20. The computer-readable medium according to claim 19, the specifying comprising:
blocking or unblocking the first user's access to a particular port on which the particular application runs to disallow or allow access to the particular application.

21. The computer-readable medium according to claim 18, when executed, the instructions further causing the computer to share at least one resource between the first device and the second device if the first user is allowed by the second user to access the second device.

22. The computer-readable medium according to claim 13, wherein the IP address of the first device is a public IP address or a private IP address.

23. The computer-readable medium according to claim 13, wherein the first domain name is further associated with an identifier of the server.

24. The computer-readable medium according to claim 13, wherein the first domain name comprises a portion in a form of “device identifier. user identifier. server identifier”.

25. A system of communication, comprising:
a server; and
a first device used by a first user;
wherein the server:
assigning a first domain name to a first user in relation to the first user logging onto a server using a first device, the first domain name being associated with a first device identifier of the first device and a first user identifier of the first user; and
negotiating communication for the first device based on the first domain name and independent of an IP address of the first device.

26. The system according to claim 25, further comprising a second device used by a second user, and the server further assigning a second domain name to the second user when the second user logs onto the server using the second device, the second domain name being associated with a second device identifier of the second device and a second user identifier of the second user.

27. The system according to claim 26, wherein the server control access from the first device to the second device by the first user identifier.

28. The system according to claim 27, wherein the server allows or disallows the first user to see the second device.

29. The system according to claim 27, wherein the server further:
assign a third domain name to the first user when the first user logs onto the server using a third device, the third domain name being associated with a third device identifier of the third device and the first user identifier; and
allow the third device to access the second device if the first device is allowed to access the second device.

30. The system according to claim 27, wherein any device assigned with a domain name being associated with the first device identifier is authenticated to access any application running on the second device if the first user is allowed by the second user to access the second device.

31. The system according to claim 30, the authenticating comprising:
specifying whether the first user can access a particular application running on the second device by the second user.

32. The method of claim 31, the specifying comprising:
blocking or unblocking the first user's access to a particular port on which the particular application runs to disallow or allow access to the particular application.

33. The system according to claim 30, wherein at least one resource is shared between the first device and the second device if the first user is allowed by the second user to access the second device.

34. The system according to claim 25, wherein the IP address of the first device is a public IP address or a private IP address.

35. The system according to claim 25, wherein the first domain name is further associated with an identifier of the server.

36. The system according to claim 25, wherein the first domain name comprises a portion in a form of “device identifier. user identifier. server identifier”.
